(19) United States
(12) Patent Application Publication
(10) Pub. No.: US 2005/0006302 A1
(43) Pub. Date: Jan. 13, 2005

(54) Process for the preparation of porous membrane

(75) Inventors: Ulhas Kanhaiyalal Kharul, Maharashtra (IN); Yogesh Suresh Bhole, Maharashtra (IN); Harshada Ramesh Lohokare, Maharashtra (IN); Santosh Dattatraya Wanjale, Maharashtra (IN)

Correspondence Address: TRASK BRITT, P.O. BOX 2550, SALT LAKE CITY, UT, 84110, US

(73) Assignee: Council of Scientific and Industrial Research, New Delhi (IN)

(21) Appl. No.: 10/764,132

(22) Filed: Jan. 22, 2004

Related U.S. Application Data
(60) Provisional application No. 60/442,091, filed on Jan. 22, 2003.

(51) Int. Cl. B01D 71/00

(52) U.S. Cl. 210/500.24; 210/500.21

(57) ABSTRACT

The present invention relates to a porous membrane and a process for the preparation of the same by combining two or more additives, wherein said membrane, useful for ultrafiltration, shows excellent combination of high water flux and solute rejection, said method comprising steps of adding two or more additives in organic solvent(s) to obtain a dope solution, stirring the dope solution, adding polymer slowly into the dope solution, stirring the dope solution, degassing the dope solution, removing the undissolved particles to obtain homogeneous dope solution, casting the homogeneous dope solution, precipitating the cast in a non-solvent, washing the precipitated cast in running water and obtaining the porous membrane having excellent combination of high water flux and solute rejection.

### CROSS-REFERENCE TO RELATED APPLICATION

This application claims the benefit, under 35 U.S.C. § 119(e) of Provisional Patent Application 60/442,091 filed on Jan. 22, 2003, the contents of the entirety of which is incorporated by this reference.

### TECHNICAL FIELD

The present invention relates to a polymeric porous membrane and a process for the preparation of same by combining two or more additives, wherein the membrane, useful for ultrafiltration, shows excellent combination of high water flux and solute rejection, the method comprising steps of adding two or more additives in organic solvent(s) to obtain a dope solution, stirring the dope solution, adding polymer slowly into the dope solution, stirring the dope solution, degassing the dope solution, removing the undissolved particles to obtain homogeneous dope solution, casting the homogeneous dope solution, precipitating the cast in a non-solvent, washing the precipitated cast in running water, and obtaining the porous membrane having excellent combination of high water flux and solute rejection.

### BACKGROUND

Ultrafiltration membranes can be prepared using different polymers such as I polyacrylonitrile, polysulfonic, potyethersulfone, etc. The polymer solution (dope solution) is prepared by dissolving the polymer in appropriate solvent/combination of solvent and men membranes are prepared by phase inversion method; wherein, water, acetone, alcohol, etc. are used as nonsolvent. Various types of chemicals (additives) can be added to the dope solution m order to improve the membrane performance. Several types of additives are demonstrated in the literature. These additives can be either small organic molecules, inorganic salts or polymers.

Previously, preparation of semipermeable membranes based on polyacrylonitrile was demonstrated by wet-spinning method (Heger A. and Stephan M.; Ger. DD 296795 A7, 1991) and then partially drying, removing residual solvent by exchange or displacement, evaporating the exchange or displacement agent at <100°, and optionally exposing the film to radiation and treating it with monomers. Manufacture process of porous polymeric membrane using polyacrylonitrile and similar polymers is demonstrated using gelation liquids (Twaddle T. A. et al, Can. CA 1313735 A1, 1993). These membranes are prepared by casting a polymer solution in a slowly diffusing aprotic solvent, progressively submerging the cast layer in a gelation liquid to continuously remove the diffusing solvent and thereby forming a coherent, active skin layer. In a report (Buschatz, H. et al., Ger. Offen. DE 19526094 A1, 1997), the mixture of acrylonitrile and methyl acrylate polymers was used to prepare mechanically stable polyacrylonitrile membranes. Albrecht W. et al. (Ger. DE 19546837 C1, 1997) demonstrated preparation of polyacrylonitrile membranes by spinning its 17% solution in 49.8:33.2 N-methylpyrrolidone-butyrotactone at 80° using H₂O at 30° as lumen filler and 15% aqueous N-methylpyrrolidone at 30° as a precipitation bath. In an another report, membrane formed by an acrylonitrile-based polymer are demonstrated (Gentile, F. et al; U.S. Pat. No. 5,720,969 A, 1998), which are formed by converting into intermediate reactive sites a portion of the cyano groups of a backbone polymer and grafting polyalkylene oxide polymer chains to the backbone polymer through the reactive sites. Hydrophilic ultrafiltration hollow fiber membranes are demonstrated by Ishibashi Y. and Abe T. (JP 2001017841 A2, 2001). These ultrafiltration membranes are formed from polyacrylonitrile based polymers containing inorganic salt like CaCl₂, MgCl₂, LiCl, Mg(NO3)₂ etc. in the dope solution. Kulkarni S. S. et al. demonstrated the use of inorganic salts as the additive in the dope solution to mate ultrafiltration membrane (Indian Pat. Appl. NF-92/96, 1996). Another study reports modified, polyacrylonitrile-containing membranes suitable for ultrafiltration (Linder C. et ml U.S. Pat. No. 4,584,103, 1986), which are prepared by reacting polyacrylonitrile or its copolymers and other ethylenically unsaturated monomers with, successively, hydroxymine, at least difunctional compounds, which act as bridge members, e.g., cyanuric chloride, a polyfunctional oligomer or polymer, e.g., polyethyleneimine, and, finally, a reactive compound like anionic reactive compound like anionic reaction azo dye. The novel membranes show good mechanical, temperature and pH-stabilities. Buschaiz et al. (DE 19811998, 1999) demonstrated solvent-resistant PAN membranes based on polyacrylonitrile (PAN) copolymers that are obtained by phase inversion, using a co-monomer with cross-linking reactive group(s) and performing the cross-linking reaction during and/or after membrane forming. Production of hollow fiber filter membrane was demonstrated by Ozushi (JP 2000033242, 2000). A spinning solution obtained by mixing an acrylonitrile copolymer in nitric acid is extruded for producing hollow fibers. Polyamide membranes with bovine serum albumin inhibition rate of 98.8% have H₂O permeation flux of 11.3 1/m2-h-kPa (JP 11217459 A2 1999). A regenerated cellulose membrane having 100% beef-serum albumin exclusion rate showed water permeability of 45 L/m2-h (JP 03065224 A2 1991). Chloromethylated and quaternized polysulfone-poly (vinylidene chloride) blend membranes with 99% bovine serum albumin rejection rate showed flux of 98 L/m2.h (Hao J. et al; Shuichuli Jishu, 22(6), 319-322, 1996; CA: 126:75796). Polyacrylonitrile based UF membrane with high flux were demonstrated by Wu_K. et (Mo Kexue Yu Jishu. 19(3), 41-30,1999; CA: I3>:311362). which snowed cut off of relative mol. wt. 150,000 and water flux 150-200 mL/(cm2xh). Inorganic UP Carbosep membrane having cut-off of 50 Kda showed water flux of 100 bnh (Abdessemed, D. et al; Desalination, 126(1-3), -5, 1999). Manufacture of porous vinylidene fluoride polymer ultrafiltration membranes is reported by Kawai T. et. al. (JP 63296940 A2 1988), which exhibited pure H₂O permeation rate of 340 mL/m2-h-mmHg and albumin rejection of 69%. Another Porous vinylidene fluoride membrane with albumin rejection of 95% showed pure water permeation rate of 90 mLAn2-h-mmHg (JP 63296939 A2 1988). An acrylonitrile copolymer based membrane with 94.7% 8SA rejection showed water flux of 54.8 μsa (Wenli et al, J. Appl. Polym ScL 74,1271-1277, 1999). Ghosh and Cui reported a water flux of 50 kDa MWCO polysulfone membrane to be 0.00506 kg.m⁻²s⁻¹ V (J. Membr. Sci., 139(1), 17-28, 1998).

None of the above documented literature demonstrated the use of organic acid containing two or more carboxyl or sulfonic acid groups is an additive to form ultrafiltration membrane based on polyacrylonitrile. These organic acids may have electrostatic interactions with solvent well as polymer present in dope solution and are basic in nature. This ultimately has its effect during phase inversion process and thus result in improved membrane performance. In phase inversion process, polymer present in the dope solution undergo a change of phase when dipped in nonsolvent During this process, solvent present in the dope solution is extracted by the nonsolvent It is hypothesized that if solvent is present in the form of some complex with organic acid having two or more acid functional groups; during phase inversion process, extraction of solvent by nonsolvent would be more defined or regulated by the solvent-acid complex. This gives rise to well defined porosity in the resulting membrane. This would finally remit in improved membrane performance. The effect can be dependant on the nature of the acid used. i.e. number of carboxyl groups present, its water and solvent solubility etc. Such parameters are varied in the present invention and the membrane performance improvement demonstrated.

### SUMMARY OF THE INVENTION

The present invention relates to a polymeric porous membrane and a process for preparation of the same by combining two or more additives, wherein the membrane, useful for ultrafiltration, shows excellent combination of high water flux and solute rejection, the method comprising steps of adding two or more additives in organic solvent(s) to obtain a dope solution, stirring the dope solution, adding polymer slowly into the dope solution, stirring the dope solution, degassing the dope solution, removing the undissolved particles to obtain homogeneous dope solution, casting the homogeneous dope solution, precipitating the cast in a non-solvent, washing the precipitated cast in running water, and obtaining the porous membrane having excellent combination of high water flux and solute rejection.

The present invention provides a porous membrane of polymers by combining two or more additives.

The invention also provides a polymeric porous membrane useful for ultrafiltration, shows excellent combination of high water flux and solute rejection.

The invention also relates to the development of a process for the preparation of a porous membrane of polymers by combining two or more additives.

The present invention also relates to developments in a process of preparing membrane useful for ultrafiltration, shows excellent combination of high water flux and solute rejection.

The present invention also relates to developments in a process of preparing the an efficient membrane using one or more organic solvents.

The present invention also provides a process for preparation of porous membranes based on polyacrylonitrile in particular, using organic acid containing two or more carboxyl or sulfonic acid groups as an additive, which can provide the membrane with better performance in terms of increased flux and rejection. By varying the membrane preparation parameters like polymer concentration in dope solution and its composition, nature of nonsolvent and its compositions, and casting conditions etc.; average pore size of these membranes can be varied as required.

### DETAILED DESCRIPTION OF THE PRESENT INVENTION

Accordingly, the present invention relates to a polymeric porous membrane and a process for preparation of the same by combining two or more additives, wherein the membrane, useful for ultrafiltration, shows excellent combination of high water flux and solute rejection, the method comprising steps of adding two or more additives in organic solvent(s) to obtain a dope solution, stirring the dope solution, adding polymer slowly into the dope solution, stirring the dope solution, degassing the dope solution, removing the undissolved particles to obtain homogeneous dope solution, casting the homogeneous dope solution, precipitating the cast in a non-solvent, washing the precipitated cast in running water, and obtaining the porous membrane having excellent combination of high water flux and solute rejection.

In still another embodiment of the present invention, wherein a polymeric porous membrane comprising two or more additives shows excellent combination of high water flux and solute rejection.

In still another embodiment of the present invention, the porous membrane thickness varies in the range of 8.5 to 15 mil.

In still another embodiment of the present invention, the porous membrane water flux at 0.5 bar varies in the range 22 to 370 ltm⁻²h⁻¹.

In still another embodiment of the present invention, the porous membrane water flux at 1 bar varies in the range 47 to 1120 ltm⁻²h⁻¹.

In still another embodiment of the present invention, BSA rejection of the porous membrane varies in the range of 80 to 100%.

In still another embodiment of the present invention, wherein a process for the preparation of a porous membrane of polymers by combining two or more additives, wherein the membrane, useful for ultrafiltration, shows excellent combination of high water flux and solute rejection, the method comprising steps of:
adding two or more additives in organic solvent(s) to obtain a dope solution,
stirring the dope solution,
adding polymer slowly into the dope solution,
stirring the dope solution,
degassing the dope solution,
removing the undissolved particles to obtain homogeneous dope solution,
casting the homogeneous dope solution,
precipitating the cast in a non-solvent,
washing the precipitated cast in running water, and
obtaining the porous membrane having excellent combination of high water flux and solute rejection.

In still another embodiment of the present invention, wherein organic solvent is selected from a group comprising N, N-dimethyl formamide (DMF), N, N-dimethyl acetamide (DMAc), N-methyl pyrolidone (NMP), and dimethyl sulfoxide (DMSO).

In still another embodiment of the present invention, the concentration of organic solvent in dope solution ranges between 0.1 to 35% (w/w).

In still another embodiment of the present invention, the organic acid is a mixture of two or more solvents in the ratio ranging between 1:99 to 99:1.

In still another embodiment of the present invention, the additives are selected from a group comprising organic acids, inorganic salts, and viscosity enhancing agent.

In still another embodiment of the present invention, wherein the additive organic acid is selected from a group comprising tartaric acid, fumaric acid, maleic acid, malonic acid, malic acid, citric acid, lactic acid, polylactic acid, polyacrylic acid, polystyrene sulfonic acid, their partial or total alkali or alkaline earth metal salts, or any other acid containing two or more carboxyl or sulfonic acid groups.

In still another embodiment of the present invention, inorganic salts are selected for a group comprising halides, and nitrates of Gr. I (A/B), II (A/B) elements of periodic table, and metals Fe, Al, Co, Ru, Zn, Cd, and Hg.

In still another embodiment of the present invention, the concentration of inorganic salt in the dope solution ranges between 0.1-15% (w/w).

In still another embodiment of the present invention, wherein viscosity enhancing agent is selected from a group comprising glycerol, water, poly vinyl pyrolidone, polyethylene glycol, and polyethylene oxide.

In still another embodiment of the present invention, the concentration of viscosity enhancing agents in dope solution is ranging between 0.1-30% (w/w).

In still another embodiment of the present invention, the polymer is selected from a group comprising polyacrylonitrile, polysulfone, and polyethersulfone.

In still another embodiment of the present invention, the polymer is polyacrylonitrile.

In still another embodiment of the present invention, the concentration of polymer ranges between 5-30% (w/w).

In still another embodiment of the present invention, the degassing of dope solution is for the time duration ranging between 5-25 minutes.

In still another embodiment of the present invention, the undissolved particles are removed by centrifugation or filtration.

In still another embodiment of the present invention, the non-solvent is selected from a group comprising water, acetone, and alcohol.

In still another embodiment of the present invention, the non-solvent is water.

In still another embodiment of the present invention, the alcohol is selected from a group comprising methanol, ethanol, and iso propanol, or a mixture thereof.

In still another embodiment of the present invention, the non-solvent is miscible with both organic solvent and the additives.

In still another embodiment of the present invention, the process is carried out at temperature ranging between 4-50° C.

In still another embodiment of the present invention, the process is carried out at a temperature ranging between 10-30° C.

In still another embodiment of the present invention, the membrane can be prepared in both flat sheet form and hollow fiber form.

A novel aspect of the specification is that membrane preparation is done using organic acid as additives, which are expected to have interactions with solvent used for the dissolution of the polymer. The formed solution is called as dope solution and used for membrane making by sol-gel-precipitation process, using water as non-solvent. Thus in this process, the complex of solvent and additive (organic acid) formed in the dope solution is anticipated to leach out in water (used as nonsolvent) in a well defined manner and we postulate that this phenomenon is responsible for improvement in membrane performance.

In still another embodiment of the present invention, the membrane formed is ultra/micro-filtration in nature.

Accordingly, the present invention provides an improved process for preparation of porous membranes, using organic acid as additive; which comprises preparing the dope solution by dissolving organic acids or mixture thereof, optionally adding an inorganic salt and/or viscosity enhancing agents in an organic solvent, dissolving 6-26% (w/w) polyacrylonitrile under agitation, removing undissolved particles and entrapped gases, if any, by known conventional methods, preparing the membranes using this solution by gelling in a bath containing an appropriate nonsolvent by conventional methods like casting or spinning to obtain the porous membrane.

In one of the embodiment of the present invention, the organic acid used as additive in the dope solution that is used for membrane preparation may be aliphatic or aromatic or saturated or unsaturated, or oligomeric or polymeric in nature or suitable combinations of these; containing two or more carboxyl or sulfonic acid groups (in free acid or suitable salt form) like tartaric acid fumaric acid, maleic acid, malonic acid, malic acid, citric acid, lactic acid, polylactic acid of various molecular weight, polyacrylic acid of various molecular weight, polystyrene sulfonic acid of various molecular weight or their partial or total alkali or alkaline earth metal salts, or any other acid containing two or more carboxyl or sulfonic acid groups, which is soluble in both, solvent used for dissolving the polymer, as well as nonsolvent used for membrane preparation.

In another embodiment, the concentration of the organic acid in dope solution may be 0.1 to 35% (w/w).

In still another embodiment, the additive may be mixture of organic acid and inorganic salt selected from halides, nitrates or similar salts of Gr. I(A/B), II(A/B) elements of periodic table or any other metals like Fe, Al, Co, Ru, Zn, Cd, Hg.

In yet another embodiment, the concentration of inorganic salt in the dope solution may be 0-15% (w/w).

In still another embodiment, the additive may be mixture of organic acid and viscosity enhancing agents like glycerol, water or any suitable oligomer or polymer of desired molecular weight like poly vinyl pyrrolidone or polyethylene glycol, polyethylene oxide etc.

In yet another embodiment, the concentration of viscosity enhancing agents in (he dope solution may be 0-30% (w/w).

In still another embodiment, the additive used in the dope solution may be an appropriate mixture of organic acid, inorganic salt and viscosity enhancing agent as above mentioned.

In yet another embodiment, the solvent used for dissolving the polymer and additive may be N′,N′-dimethyl formamide (DMF), \hat{ }A′-dimethyl acetamide (DMAc), N′-methyl pyrrolidone (NMP), dimethyl sulfoxide (DMSO) or any other organic solvent or mixtures thereof.

In still another embodiment, the mixture of solvents may be a mixture of minimum two solvents as mentioned above in any proportion.

In yet another embodiment, the nonsolvent used for gelation and precipitation of the dope solution during membrane formation may be water, acetone, alcohols such as methanol, ethanol, isopropanol or mixture thereof or an appropriate mixture of solvent and nonsolvent

In still another embodiment, the appropriate nonsolvent to the polyacrylonitrile used for preparation of membranes is miscible with organic solvent used to prepare the dope solution:

In yet another embodiment, the appropriate nonsolvent to the polyacrylonitrile used for casting the membranes is capable of dissolving the additives. In another embodiment, the membrane preparation may be done at 4-50° C., preferably at 10-30° C.

In a feature of the present invention, the membrane may be prepared by conventional phase inversion method either in flat sheet form or hollow fiber form. In another feature of the present invention, flat sheet membrane can be prepared on a moving porous backing like nonwoven or woven fabric.

In still another feature of the present invention, membrane in hollow fiber form can prepared by passing dope solution through a spinneret followed by gelation and precipitation in appropriate nonsolvent.

In still another feature of the present invention, the flat sheet membrane can be wound in spiral form using conventional technique.

In still another feature of the present invention, the dope solution composition can be suitably adjusted such that the formed membrane has complete retention of pathogenic species like viruses, bacteria, etc. and still have high water flux.

The process of the present invention is described herein with the help of following examples, which are illustrative only and should not be construed to limit the scope of the present invention in any manner. In these examples, the organic acid having two or more carboxyl or sulfonic acid groups is used as an additive in the dope solution used for membrane formation. In some cases, in addition to organic acid, other types of additives like inorganic salts or viscosity enhancing agents can also be used. The membrane preparation conditions in all these examples were conveniently adjusted such that the solute rejection behavior can be observed using the single protein-bovine serum-albumin (BSA) and flux variation performance can be easily compared. It is possible to change the parameters and obtain the membrane with required porosity i.e. Molecular Weight Cut Off (MWCO), in which case, the solute rejection can be observed using conventional solutes like proteins, Polyethylene Glycol (PEG) or dextran of varying molecular weight.

The present invention relates to an improved process for preparation of porous membranes. More particularly, it relates to based on polyacrylonitrile and fell in ultra/microfiltration type. These membranes are prepared by phase inversion method using a novel class of additives. These additives are organic acids containing two or more carboxyl sulfonic acid groups, which can form complexes with solvent and the polymer. Membranes prepared using the process have excellent combination of high flux and high solute rejection. Additionally, membranes with various porosities and with a good control on pore size and its distribution can be prepared by this method. Thus these membranes can be used to separate solutes from various solutions and separation of low molecular weight species from high molecular ones in various applications like pharmaceutical, food and dairy industry, disinfection of water (removal of pathogenic species like viruses, bacterial, cysts, spores, etc.) and other water treatment applications such as waste water and sewage treatment, separation or concentration of proteins from various solutions, etc. These membranes can also be used as a base for preparation of Thin Film Composite (TFC) membranes used for various applications such as gas separation. Thus these membranes can find applications in various industrial as well as domestic separation areas.

Present invention claims a process for porous membrane preparation (microfiltration/ultrafiltration type) based on acrylonitrile using novel class of additives. During the membranes preparation by phase inversion method, additives present in the dope solution (polymer solution used for membrane preparation) play an important role in governing porosity and pore density of the membrane during gelation process (sol-gel-precipitation process). Various types of additive are reported in the literature like inorganic salts (LiCl, AlCl₃, ZnCl₂), polymers (polyvinyl pyrrolidone, polyethylene glycol, etc), organic molecules like glycerol and nonsolvents like water and alcohols. These additives either increases viscosity, vary thermodynamic stability of dope solution used for membrane casting or form complex with polymer used for membrane preparation and thereby have a control on pore formation.

No literature is available which uses organic acid (small molecules or polymeric in nature) containing two or more carboxyl or sulfonic acid groups (or their salts) as an additive to form porous membrane based on polyacrylonitrile. Present work is based on using such acids in the dope solution, which are anticipated to form complexes with the solvent (which is basic in nature like DMF, NMP and DMAc). During the phase change (solution to gelation and finally precipitation), the removal of solvent from the solution phase by the nonsolvent (usually water) is crucial. It is hypothesized that if the solvent is removed in a defined manner, i.e. in the form of complex with acids, it would have its on effect on control on the porosity. And this is what is explored in the present work. As postulated, an effect of controlled removal of solvent resulted in higher flux (higher pore density) without adversely affecting the rejection performance (pore size).

The flux (water permeation) is increased dramatically in comparison to membranes prepared by using known additives like ZnCl₂. In order to compare the performance of additives in the present work, membranes are prepared such that obtained porosity is similar (as judged by BSA rejection in the range of 85-100%). The promising membranes in this work showed 4-6 time higher flux (water permeation) and similar rejection performance than the conventional membranes (e.g., earlier demonstrated membranes for which NCL has transferred a technology; Indian Patent Appl. No: 1811/DEL/96) and also than the reported ones as given below:

The literature survey was done using available databases (Patent databases, CA on CD, internet sites). No literature was found which uses organic acid containing two or more carboxyl or sulfonic acid groups (or their salts) as an additive to form ultrafiltration membrane based on polyacrylonitrile. Following table compared the performance of present membranes with reported ones. A data is selected from the literature for membranes having comparable porosity as that of present membranes.

| | | | |
|---|---|---|---|
| | Rejection | | |
| Details of | performance | | |
| membrane | of BSA (%) or | | Ref. |
| (type/material | Pore size | Water Flux | (given |
| of construction) | (MWCO) | (lmh/m⁻² · h-bar) | below) |

Examples from present work

| Example. 2 | 81-91% | | 517-573 | lmh | Present |
|---|---|---|---|---|---|
| Example. 5 | 90-96% | | 690-765 | lmh | work |
| Example. 6 | 94-100% | | 383-393 | lmh | |
| Example. 8 | 94-98% | | 207-211 | lmh | |
| Example. 12 | 82-86% | | 903-1115 | lmh | |
| Example. 20 | 90-96% | | 209-233 | lmh | |
| Polyacrylonitrile | 90-100%, | | 80 | lmh | 1 |
| (NCL's earlier | 65 | kDa | | | |
| process) | | | | | |
| Polyamide resin | 98.8 | | 11.03 | l/m⁻² · h-kPa | 2 |
| based | | | | | |
| Polysulfone-PVDF | 99 | | 98 | | 3 |
| blend | | | | | |
| P(AN-co- | 100 | | 194 | | 4 |
| acrylamide) | 83 | | 207 | | |
| Polysulfone | 50 | kDa | 91 | | 5 |
| based | | | | | |
| Polysulfone | 40 | kDa | 58 | | |
| based | 78 | kDa | 75 | | 6 |
| PVDF membranes | 69% | | 255 | | 7 |
| PVDF membranes | 95% | | 68 | | 8 |
| Cellulose based | 100 | | 45 | | 9 |

| | | | | |
|---|---|---|---|---|
| Polysulfone | 150 | kDa | 54-125 | 10 |
| Polyacrylonitrile | 13 | kDa | 42-96.5 | 11 |

### References

1 Kulkarni S. S. et al Indian Patent Appl. No: 1811/DEU96
2 Watanabe et al; JP 11217459 (1999)
3 Hao et al; CA 126: 75796 (1996)
4 Wenli H. et al; J. Appl. Polym. Sci. 74 1271-77 (1999)
5 R. Ghosh et al, J. Membr. Sci. 139 17-28 (1998)
6 Sue et al.; J. Membr. Sci. 119 59-64 (1996)
7 Kawai et al.; JP 63296940 (1988)
8 Kawai et al.; JP 63296939 (1988)
9 Nakamura et al; JP 03065224 (1991)
10 Hydracap membranes (Commercial Membrane from Hydranotics)
11 Microza (Commercial Membrane from Asahi)
   So, the novelty of the invention can be based on following facts:
   1. Remarkable increase in the water flux for promising membranes (4-6 times) without affecting the rejection performance (in comparison with existing membranes).
   2. A totally new class of additives used in the dope solution that has (i) ability to form complexes with solvent
   3. Demonstrated unexplored route of affecting gelation thermodynamics. Thus these additives have totally different mechanism of pore formation than the explored in the literature.

The concept explored in the invention relates to the mechanism of pore formation of ultrafiltration membranes prepared by phase inversion method, which can be extended to microfiltration membranes as well (not tried in this work). Thus the work has a potential, which can be applicable to all types of porous membrane formation by phase inversion method.

The invention is further elaborated with the help of following examples. However, the examples should not be construed to limit the scope of the invention

### EXAMPLE 1

A solution was prepared by adding 10.584 g of maleic acid in 289.42 g of dry M#-dimethyl formamide (DMF) while stirring for 16 hours at ambient temperature. 44.83 g of polyacrylonitrile was added slowly and stirred for 72 hours, using a mechanical stirrer at ambient temperature. The formed dope solution was degassed for 0.5 minute and then undissolved particles were removed by centrifugation at 2300 rpm. The membrane was prepared by casting the dope solution on a running non-woven polyester fabric (Hollytex) followed by precipitation in water at ambient temperature and then washed under running water. The small coupons of 15.1976 cm² area were cut from each membrane and analyzed for water flux and rejection performance of Bovine Serum Albumin (BSA). The results obtained are tabulated in Table 1.

TABLE 1
Performance of the membranes prepared
as demonstrated in Example 1

| | | | |
|---|---|---|---|
| | Membrane | Average water flux | |
| Coupon | thickness | (It · m-² · h⁻¹) | BSA |

| No. | (mil) | At 0.5 bar | At 1 bar | Rejection (%) |
|---|---|---|---|---|
| A1-a | 12 | 208 | 505 | 91 |
| A1-b | 12 | 239 | 534 | 100 |
| A1-c | 11.5 | 243 | 504 | 100 |

### EXAMPLE 2

A solution was prepared by adding 10.224 g of maleic acid in 289.8 g of dry DMF while stirring for 12 hours at ambient temperature. 52.94 g of polyacrylonitrile was added slowly and stirred using a mechanical stirrer for 24 hours at ambient temperature. The formed dope solution was degassed for 13 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of 15.1976 cm² area were cut from each membrane and analyzed for water flux and BSA rejection performance. The results obtained are tabulated in Table 2

TABLE 2
Performance of the membranes prepared
as demonstrated in Example 2.

| | | | |
|---|---|---|---|
| | Membrane | Average water flux | |
| Coupon | thickness | (It · m-² · h⁻¹) | BSA |

| No. | (mil) | At 0.5 bar | At 1 bar | Rejection (%) |
|---|---|---|---|---|
| A2 -a | 12 | 263 | 560 | 81 |
| A2-b | 11.5 | 282 | 517 | 91 |
| A2-c | 11.5 | 264 | 573 | 89 |

### EXAMPLE 3

A solution was prepared by adding 7.92 g of oxalic acid in 292.1 g dry DMF while stirring for 12 hours at ambient temperature. 52.94 g of polyacrylonitrile was added slowly and stirred for 24 hours, using a mechanical stirrer at ambient temperature. The formed dope solution was degassed for 12.3 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of 15.1976 cm² area were cut from each membrane and analyzed for water flux and BSA rejection performance. The results obtained are tabulated in Table 3

TABLE 3
Performance of the membranes prepared
as demonstrated in Example 3.

| | | | |
|---|---|---|---|
| | Membrane | Average water flux | |
| Coupon | thickness | (lt · m_² · h⁻¹) | BSA |

| No. | (mil)\| | At 0.5 bar | At 1 bar | Rejection (%) |
|---|---|---|---|---|
| B2-a | 12-12.5 | 127 | 244 | 94 |
| 82-b | 11 | 126 | 262 | 89 |

### EXAMPLE 4

A solution was prepared by adding 8.133 g of oxalic acid in 291.86 g dry DMF while stirring for 12 hours at ambient temperature. 52.94 g of polyacrylonitrile was added slowly and stirred for 24 hours, using a mechanical stirrer at ambient temperature. The formed dope solution was degassed for 10.4 minute and then undissolved particles were removed by centrifugation at 2700 rpm. The membrane was prepared by casting the dope solution on a non-woven polyester fabric (Viledon) followed by precipitation in water at ambient temperature and then washed under running water. The small coupons of 15.1976 cm² area were cut from each membrane and analyzed for water flux and BSA rejection performance. The results obtained are tabulated in Table 4.

TABLE 4
Performance of the membranes prepared
as demonstrated in Example 4.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| B4-a | 9.5 | 84 | 161 | 90 |
| B4-b | 9 | 78 | 159 | 92 |
| B4-c | 9 | 82 | 155 | 90 |
| B4-d | 8.5-9 | 80 | 158 | 91 |

### EXAMPLE 5

A solution was prepared by adding 17.931 g of citric acid in 282.07 g dry DMF while stirring for 12 hours at ambient temperature. 44.83 g of polyacrylonitrile was added slowly and stirred for 48 hours, using a mechanical stirrer at ambient temperature. The formed dope solution was degassed for 10 minute and then undissolved particles were removed by centrifugation at 2300 rpm. The membrane was prepared by casting the dope solution on a non-woven polyester fabric (Hollytex) followed by precipitation in water at ambient temperature and then washed under running water. The small coupons of 15.1976 cm² area were cut from each membrane and analyzed for water flux and BSA rejection performance. The results obtained are tabulated in Table 5.

TABLE 5
Performance of the membranes prepared
as demonstrated in Example 5.

| | | | |
|---|---|---|---|
| | Membrane | Average water flux | |
| Coupon | thickness | (h · m² · h′) | BSA |

| No. | (mil) | At 0.5 bar | At 1 bar | Rejection (%) |
|---|---|---|---|---|
| C1-a | 11.5 | 315 | 765 | 95 |
| C1-b | 12-13 | 350 | 699 | 90 |
| C1-c | 12-13 | 367 | 690 | 96 |
| C1-d | 13-13.5 | 288 | 554 | 97 |
| C1-e | 13 | 344 | 694 | 96 |

### EXAMPLE 6

A solution was prepared by adding 282 g of citric acid in 471.8 g dry DMF while stirring for 12 hours at ambient temperature. 88.24 g of polyacrylonitrile was added slowly and stirred for 24 hours, using a mechanical stirrer at ambient temperature. The formed dope solution was degassed for more than 15 minute and then undissolved particles were removed by centrifrugation at 2300 rpm. The membrane was prepared by casting the dope solution on a non-woven polyester fabric (Hollytex) followed by precipitation in water at ambient temperature and then washed under running water. The small coupons of 15.1976 cm″ area were cut from each membrane and analyzed for water flux and BSA rejection performance. The results obtained are tabulated in Table 6

TABLE 6
Performance of the membranes prepared
as demonstrated in Example 6.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| C2-d | 11.5 | 201 | 383 | 94 |
| C2-e | 11-11.5 | 200 | 393 | 100 |

### EXAMPLE 7

A solution was prepared by adding 6.471 g of polyacylic acid 2000 (PAA average Mw 2K) and 293.53 g dry DMF while stirring for 12 hours at ambient temperature. 44.83 g polyacrylonitrile was added slowly and stirred for 72 hours, using a mechanical stirrer at ambient temperature. The formed dope solution was degassed for 11 minute and then undissolved particles were removed by centrifugation at 2300 rpm. The membrane was prepared by casting the dope solution on a non-woven polyester fabric (Hollytex) followed by precipitation in water at ambient temperature and then washed under running water. The small coupons of 15.1976 cm″ area were cut from each membrane and analyzed for water flux and BSA rejection performance. The results obtained are tabulated in Table 7 Table 7.

TABLE 7
Performance of the membranes prepared
as demonstrated in Example 7.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| D1-a | 12-12.5 | 158 | 314 | 92 |
| D1-b | 11-11.5 | 158 | 283 | 95 |
| D1-c | 11-11.5 | 161 | 322 | 93 |

### EXAMPLE 8

A solution was prepared by adding 6.28 g of polyacylic acid 2000 (PAA average Mw 2K) and 291.2 g dry DMF whisk stirring for 12 hours at ambient temperature. 52.5 g polyacrylonitrile was added slowly and stirred for 72 hours, using a mechanical stirrer at ambient temperature. The formed dope solution was degassed for 11 minute and then undissolved particles were removed by centrifugation at 2500 rpm. The membrane was prepared by casting the dope solution on a non-woven polyester fabric (Viledon) followed by precipitation in water at ambient temperature and then washed under running wafer. The small coupons of 15.1976 cm² area were cut from each membrane and analyzed for water flux and BSA rejection performance. The results obtained are tabulated in Table 8.

TABLE 8
Performance of the membranes prepared
as demonstrated in Example 8.

| | | | |
|---|---|---|---|
| | Membrane | Average water flux | |
| Coupon | thickness | (It · m⁻² · h⁻¹) | BSA |

| No. | (mil) | At 0.5 bar | At 1 bar | Rejection (%) |
|---|---|---|---|---|
| D10-a | 13 | 106 | 208 | 97 |
| D10-b | 12-12.5 | 107 | 209 | 98 |
| D10-d | 12.5-13 | 107 | 207 | 94 |
| D10-e | 12-13 | 107 | 211 | 97 |

### EXAMPLE 9

A solution was prepared by adding 6.28 g of polyacrylic acid 2000 (PAA average Mw 2K) and 291.2 g dry DMF while stirring for 12 hours at ambient temperature. 52.5 g polyacrylonitrile was added slowly and stirred for 72 hours, using a mechanical stirrer at ambient temperature. The formed dope solution was degassed for 11 minute and then undissolved particles were removed by centrifugation at 250 rpm. The membrane was prepared by casting the dope solution on a non-woven polyester fabric (Hollytex) followed by precipitation in water at ambient temperature and then washed under running water. The small coupons of 15.1976 cm² area were cut from each membrane and analyzed for water flux <<x) BSA rejection performance. The results obtained are tabulated in Table 9.

TABLE 9
Performance of the membranes prepared
as demonstrated in Example 9.

| | Membrane | Average water flue | | |
|---|---|---|---|---|
| Coupon | thickness | (lt · m⁻² · h⁻¹) | | BSA |
| No. | (mil) | At 0.5 bar | At! (MT | Rejection (%) |
| D11-a | 11.5-12 | 153 | 306 | 97 |
| Dll-b | 13 | 159 | 303 | 98 |
| Dll-c | 14.5-15 | U3 | 257 | 98 |

### EXAMPLE 10

A solution was prepared by adding 5.068 g of polyacylic acid 4,50,000 (PAA average Mw 450K) and 234.93 g dry DMF while stirring for 12 hours at ambient temperature. 42348 g polyacrylonitrile was added slowly and stirred for 48 hours, using a mechanical stirrer at ambient temperature. The formed dope solution was degassed for 12.30 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of '15.1976 cm² area were cut from each membrane and analyzed for water flux and BSA rejection performance. The results obtained are tabulated in Table 10.

TABLE 10
Performance of the membranes prepared
as demonstrated in Example 10.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection <%) |
|---|---|---|---|---|
| G2-a | 12.5 | 297 | 588 | 100 |
| G2-b | 12 | 305 | 591 | 100 |
| G2-c | 12-13 | 274 | 524 | 100 |

### EXAMPLE 11

A solution was prepared by adding 8.52 g of maleic acid and 231.48 g dry DMF while stirring for 12 hours at ambient temperature. 44.12 polyacrylonitrile was added slowly and stirred for 24 hours, using a mechanical stirrer at ambient temperature. The formed dope solution was degassed for 12.15 minute and then undissolved particles were removed by centrifugation at 2200 rpm. The membrane was prepared by casting the dope solution on a non-woven polyester fabric (Viledon) followed by precipitation in water at ambient temperature and then washed under running water. The small coupons of 15.1976 cm′ area were cut from each membrane and analyzed for water flux and BSA rejection performance. The results obtained are tabulated in Table 11.

TABLE 11
Performance of the membranes prepared
as demonstrated in Example 11.

| | | | |
|---|---|---|---|
| | Membrane | Average water flux | |
| Coupon | thickness | (lt · m⁻² · h⁻¹) | BSA |

| No. | (mil) | At 0.5 bar | All bar | Rejection (%) |
|---|---|---|---|---|
| H4-a | 11 | 88 | 174 | 96 |
| H4-b | 12 | 97 | 194 | 98 |
| H4-c | 11.5 | 100 | 198 | 98 |

### EXAMPLE 12

A solution was prepared by adding 16.91 g of citric acid and 12 g of zinc chloride in 271.1 g dry DMF while stirring for 12 hours at ambient temperature. 44.83 g polyacrylonitrile was added slowly and stirred for 48 hours, using a mechanical stirrer at ambient temperature. The formed dope solution was degassed for 12 minute and then undissolved particles were removed by centrifugation at 2300 rpm. The membrane was prepared by casting the dope solution on a non-woven polyester fabric (Hollytex) followed by precipitation in water at ambient temperature and then washed under running water. The small coupons of 15.1976 cm^{:} area were cut from each membrane and analyzed for water flux and BSA rejection performance. The results obtained are tabulated in Table 12.

TABLE 12
Performance of the membranes prepared
as demonstrated in Example 12.

| | | | |
|---|---|---|---|
| | Membrane | Average water flux | |
| Coupon | thickness | (lt · m⁻² · h⁻¹) | BSA |

| No. | (mil) | At 0.5 bar | At I bar | Rejection (%) |
|---|---|---|---|---|
| J1-a | 11 | 549 | 1115 | 86 |
| J1-b | 10.5 | 488 | 903 | 82 |
| J1-c | 10.5-11 | 405 | 980 | 85 |

### EXAMPLE 13

A solution was prepared by adding 11.28 g of citric acid and 8 g of zinc chloride in 180.72 g dry DMF while stirring for 12 hours at ambient temperature. 35.3 g polyacrylonitrile was added slowly and stirred for 48 hours, using a mechanical stirrer at ambient temperature. The formed dope solution was degassed for 12 minute and then undissolved particles were removed by centrifugation at 2300 rpm. The membrane was prepared by casting the dope solution on a non-woven polyester fabric (Hollytex) followed by precipitation in water at ambient temperature and then washed under running water. The small coupons of 15.1976 cm² area were cut from each membrane and analyzed for water flux and BSA rejection performance. The results obtained are tabulated in Table 13.

TABLE 13
Performance of the membranes prepared
as demonstrated in Example 13.

| | | | |
|---|---|---|---|
| | Membrane | Average water flux | |
| Coupon | thickness | (lt · m⁻² · h⁻¹) | BSA |

| No. | (mil) | At 0.5 bar | At I bar | Rejection (%) |
|---|---|---|---|---|
| J2-a | 11.5 | 265 | 534 | 90 |
| J2-b | 10.5 | 267 | 533 | 94 |
| J2-c | 11 | 257 | 505 | 90 |
| J2-e | 12 | 249 | 506 | 94 |

### EXAMPLE 14

A solution was prepared by adding 6.336 g of polyacrylic acid 2000 (average Mw 2 k) and 12 g of zinc chloride in 281.7 g dry DMF while stirring for 12 hours at ambient temperature. 44.83 g polyacrylonitrile was added slowly and stirred for 48 hours, using a mechanical stirrer at ambient temperature. The formed dope solution was degassed for 13.39 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of 15.1976 cm˜ area were cut from each membrane and analyzed for water flux and BSA rejection performance. The results obtained are tabulated in Table 14.

TABLE 14
Performance of the membranes prepared
as demonstrated in Example 14.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| K1-a | 11 | 301 | 581 | 86 |
| K1-b | 11.5 | 311 | 607 | 86 |
| K1-c | 11 | 312 | 620 | 82 |
| K1-d | 11 | 287 | 604 | 80 |

### EXAMPLE 15

A solution was prepared by adding 6.336 g of polyacrylic acid 2000 (average Mw 2 k) and 12 g of zinc chloride in 281.7 g dry DMF while stirring for 12 hours at ambient temperature. 52.95 g polyacrylonitrile was added slowly and stirred for 48 hours, using a mechanical stirrer at ambient temperature. The formed dope solution was degassed for 19 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of 15.1976 cm* area were cut from each membrane and analyzed for water flux and BSA rejection performance. The results obtained are tabulated in Table 15.

TABLE 15
Performance of the membranes prepared
as demonstrated in Example 15.

| | | | |
|---|---|---|---|
| | Membrane | Average water flux | |
| Coupon | thickness | (lt · m⁻² · h⁻¹) | BSA |

| No. | (mil) | At 0.5 bar | Atl bar | Rejection (%) |
|---|---|---|---|---|
| K2-a | 12 | 148 | 290 | 92 |
| K2-d | 11.5 | 153 | 319 | 90 |
| K2-e | 11.5 | 159 | 317 | 89 |

### EXAMPLE 16

A solution was prepared by adding 6.336 g of polyacrylic acid 2000 (average Mw 2 k) and 12 g of zinc chloride in 281.7 g dry DMF while stirring for 12 hours at ambient temperature. 44.83 g polyacrylonitrile was added slowly and stirred for 48 hours, using a mechanical stirrer at ambient temperature. The formed dope solution was degassed for 13.39 minute and then undissolved particles were removed by centrifugation at 2700 rpm. The membrane was prepared by casting the dope solution on a non-woven polyester fabric (Vitedon) followed by precipitation in water at ambient temperature and then washed under running water. The small coupons of 15.1976 cm″ area were cut from each membrane and analyzed for water flux and BSA rejection performance. The results obtained are tabulated in Table 16.

TABLE 16
Performance of the membranes prepared
as demonstrated in Example 16.

| | | | |
|---|---|---|---|
| | Membrane | Average water flux | |
| Coupon | thickness | (It · m′ · h¹) | BSA |

| No. | (mil) | At 0.5 bar | At 1 bar | Rejection (%) |
|---|---|---|---|---|
| K3-a | 9-10 | 107 | 212 | 87 |
| K3-b | 10 | 101 | 199 | 88 |
| K3-c | 10 | 92 | 212 | 87 |

### EXAMPLE 17

A solution was prepared by adding 6.336 g of polyacrylic acid 4,500,000 (average Mw 450k) and 12 g of zinc chloride in 281 7 g dry DMF while stirring for 12 hours at ambient temperature. 44.83 g polyacrylonitrile was added slowly and stirred for 48 hours, using a mechanical stirrer at ambient temperature. The formed dope solution was degassed for 21 minute and then undissolved particles were removed by centrifugation at 2700 rpm. The membrane was prepared by casting the dope solution on a non-woven polyester fabric (Hollytex) followed by precipitation in water at ambient temperature and then washed under running water. The small coupons of 1 S. 1976 cm² area were cut from each membrane and analyzed for water flux and BSA rejection performance. The results obtained are tabulated in Table 17.

TABLE 17
Performance of the membranes prepared″ as
demonstrated in Example 17.

| | | | |
|---|---|---|---|
| | Membrane | Average water flux | |
| Coupon | thickness | (lt · m⁻² · h⁻¹) | BSA |

| No. | (mil) | At 0.5 | At 1 bar | Rejection (%) |
|---|---|---|---|---|
| LI-a | 10 | 185 | 372 | 81 |
| Ll-b | 11-11.5 | 152 | 290 | 87 |
| LI-c | 10-10.5 | 218 | 415 | 82 |
| LI-d | 10 | 161 | 317 | 87 |

### EXAMPLE 18

A solution was prepared by adding 8.811 g of tartaric acid in 191.2 g dry DMF while stirring for 12 hours at ambient temperature. 29.89 g of polyacrylonitrile was added slowly and stirred for 72 hours, using a mechanical stirrer at ambient temperature. The formed dope solution was degassed and then undissolved particles were removed by centrifugation at 3200 rpm. The membrane was prepared by casting the dope solution on a non-woven polyester fabric (Hollytex) followed by precipitation in water at ambient temperature and men washed under running water. The small coupons of 15.1976 cm² area were cut from each membrane and analyzed for water flux and BSA rejection performance. The results obtained are tabulated in Table 18.

TABLE 18
Performance of the membranes prepared
as demonstrated in Example 18,

| | | | |
|---|---|---|---|
| | Membrane | Average water flux | |
| Coupon | thickness | (lt · m⁻² · h⁻¹) | BSA |

| No. | (mil) | AfO.5 | Atl bar | Rejection (%) |
|---|---|---|---|---|
| R1-a | 11 | 271 | 535 | 100 |
| R1-b | 11.5 | 267 | 484 | 98 |
| R1-c | 14-14.5 | 269 | 473 | 98 |

### EXAMPLE 19

A solution was prepared by adding 8.811 g of tartaric acid in 191.2 g dry DMF while stirring for 12 hours at ambient temperature. 29.89 g of polyacrylonitrile was added slowly and stirred for 48 hours, using a mechanical stirrer at ambient temperature. The formed dope solution was degassed and then undissolved particles were removed by centrifugation at 3200 rpm. The membrane was prepared by casting the dope solution on a non-woven polyester fabric (Hollytex) followed by precipitation in water at ambient temperature and men washed under running water. The small coupons of 15.1976 cm² area were cut from each membrane and analyzed for water flux and BSA rejection performance. The results obtained are tabulated in Table 19.

TABLE 19
Performance of the membranes prepared
as demonstrated in Example 19.

| | | | |
|---|---|---|---|
| | Membrane | Average water flux | |
| Coupon | thickness | (lt · m⁻² · h⁻¹) | BSA |

| No. | (mil) | AfO.5 bar | Atl bar | Rejection (%) |
|---|---|---|---|---|
| R3-a | 12 | 319 | 636 | 84 |
| R3-b | 12 | 339 | 705 | 81 |

### EXAMPLE 20

A solution was prepared by adding 8.811 g of tartaric acid in 191.2g dry DMF while stirring for 12 hours at ambient temperature. 35.3 g polyacrylonitrile was added slowly and stirred for 48 hours, using a mechanical stirrer at ambient temperature. The formed dope solution was degassed and then undissolved particles were removed by centrifugation. The membrane was prepared by casting the dope solution on a non-woven polyester fabric (Vitedon) followed by precipitation in water at ambient temperature and then washed under running water. The small coupons of 15.1976 cm¹ area were cut from each membrane and analyzed for water flux and BSA rejection performance. The results obtained are tabulated in Table 20.

TABLE 20
Performance of the membranes prepared
as demonstrated in example 20.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| R4-a | 10.5 | 107 | 209 | 96 |
| R4-b | 1! | 116 | 231 | 94 |
| R4-c | 10.5-11 | 115 | 228 | 90 |
| R4-d | 10.5 | 114 | 233 | 93 |

### EXAMPLE 21

A solution was prepared by adding 11.01 g of tartaric acid and 10 g zinc chloride in 239 g dry DMF white stirring for 12 hours at ambient temperature. 44.12 g polyacrylonitrile was added slowly and stirred for 24 hours, using a mechanical stirrer at ambient temperature. The formed dope solution was degassed for 12 minute and then undissolved particles were removed by centrifugation at 2700 rpm. The membrane was prepared by casting tiie dope solution on a non-woven polyester fabric (Viledon) followed by precipitation in water at ambient temperature and then washed under running water. The small coupons of IS.1976 cm′ area were cut from each membrane and analyzed for water flux and BSA rejection performance. The results obtained are tabulated in Table 21.

TABLE 21
Performance of the membranes prepared
as demonstrated in Example 21.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection W |
|---|---|---|---|---|
| S1 -a | 11 | 95 | 187 | 98 |
| S1-b | 11 | 95 | 186 | 98 |
| S1-c | 11 | 97 | 193 | 98 |
| S1-d | 11 | 97 | 195 | 99 |

Now, Examples 22 and 23 show the results with conventional additives.

### EXAMPLE 22

A solution was prepared by adding 29.88 g of zinc chloride in 717.12 g dry DMF while stirring for 12 hours at ambient temperature. 153 g polyacrylonitrile was added slowly and stirred for 48 hours, using a mechanical stirrer at ambient temperature. The formed dope solution was degassed for 20 minute and then undissolved particles were removed by centrifugation at 3000 rpm. The membrane was prepared by casting the dope solution on a non-woven polyester fabric followed by precipitation in water at ambient temperature and then washed under running water. The small coupons of 15.2 cm² area were cut from each membrane and analyzed for water flux and BSA rejection performance. The results obtained are tabulated in the appropriate table.

TABLE 22
Performance of the membranes prepared
as demonstrated in Example.

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| E28-a | 9.5-10 | 25.30 | 51.24 | 97 |
| E28-b | 10-10.5 | 22.48 | 47.35 | 95 |
| E28-c | 9.5-10.5 | 23.10 | 47.45 | 94 |
| E28-d | 10 | 26.12 | 53.24 | 96 |

### EXAMPLE 23

A solution was prepared by adding 30.6 g of zinc chloride in 734.4 g dry DMF while stirring for 12 hours at ambient temperature. 135 g polyacrylonitrile was added slowly and stirred for 48 hours, using a mechanical stirrer at ambient temperature. The formed dope solution was degassed for 16 minute and then undissolved particles were removed by centrifugation at 1700 rpm. The membrane was prepared by casting the dope solution on a non-woven polyester fabric followed by precipitation in water at ambient temperature and then washed under running water. The small coupons of 15.2 cm² area were cut from each membrane and analyzed for water flux and BSA rejection performance. The results obtained are summarized in Table 2.

TABLE 23
Performance of the membranes prepared
as demonstrated in above example

| | | | |
|---|---|---|---|
| | Membrane | Average water flux | |
| Coupon | thickness | (lt · m⁻² · h⁻¹) | BSA |

| No. | (mil) | At 0.5 bar | At 1 bar | Rejection (%) |
|---|---|---|---|---|
| E 2-a | 9 | 56.64 | 114 | 89 |
| E 2-b | 9.5 | 61.63 | 128 | 92 |
| E 2-c | 9 | 56.53 | 113.5 | 90 |
| E 2-d | 9 | 66.04 | 130 | 95 |

Advantages:
1) The membranes prepared by this method have high flux in comparison to the membrane prepared without additive or the membrane prepared with demonstrated additives like inorganic salts, glycerol, water or polyvinyl pyrrolidone for the membrane of particular porosity.
2) These additives are easily soluble in solvent used for dissolving polyacrylonitrile and generally do not cause polymer precipitation by their addition.
3) These additives are easily soluble in water and alcohol, which are generally used as a nonsolvent for membrane preparation by phase inversion method. Thus they leach out easily from the membrane after the membrane has been formed and kept in running water for enough time.
4) The average porosity of these membranes can be easily changed as per the requirement by changing various parameters mat affect membrane porosity such as concentration of the polymer in dope solution used for membrane casting, its composition, type and non-solvent composition, casting temperature and other casting conditions.
5) The membrane can be prepared by phase inversion method in the form of flat sheet, with or without support or in the hollow fiber form.
6) Polyacrylonitrile based ultrafiltration membranes are widely studied for the properties like flux and rejection performance, membrane fouling by various types of solutes and related membrane evaluations. Present membranes are prepared by using the same polymer, i.e., polyacrylonitrile and thus the membrane performance in terms of fouling and similar phenomenon can be well correlated.
7) These membranes can be used for conventional ultrafiltration applications like in water treatment, food and pharmaceutical industry, effluent treatment of various industrial processes, etc.

1. A polymeric porous membrane comprising two or more additives, said porous membrane shows excellent combination of high water flux and solute rejection.

2. The porous membrane as claimed in claim 1, wherein porous membrane thickness varies in the range of 8.5 to 15 mil.

3. The porous membrane as claimed in claim 1, wherein the water flux at 0.5 bar varies in the range 22 to 370 ltm⁻²h⁻¹.

4. The porous membrane as claimed in claim 1, wherein the water flux at 1 bar varies in the range 47 to 1120 ltm⁻²h⁻¹.

5. The porous membrane as claimed in claim 1 wherein the BSA rejection varies in the range of 80 to 100%.

6. The porous membrane as claimed in claim 1, wherein additives are selected from a group comprising organic acids, inorganic salts, and viscosity enhancing agent.

7. The porous membrane as claimed in claim 6, wherein the additive organic acid is selected from a group comprising tartaric acid, fumaric acid, maleic acid, malonic acid, malic acid, citric acid, lactic acid, polylactic acid, polyacrylic acid polystyrene sulfonic acid, their partial or total alkali or alkaline earth metal salts, or any other acid containing two or more carboxyl or sulfonic acid groups.

8. The porous membrane as claimed in claim 6, wherein inorganic salts are selected from a group comprising halides, and nitrates of Gr. I (A/B), II (A/B) elements of periodic table, and metals Fe, Al, Co, Ru, Zn, Cd, and Hg.

9. The porous membrane as claimed in claim 6, wherein concentration of inorganic salt in the dope solution is ranging between 0.1-15% (w/w).

10. The porous membrane as claimed in claim 6, wherein viscosity enhancing agent is selected from a group comprising glycerol, water, poly vinyl pyrolidone, polyethylene glycol, and polyethylene oxide.

11. The porous membrane as claimed in claim 6, concentration of viscosity enhancing agents in dope solution is ranging between 0.1-30% (w/w).

12. The porous membrane as claimed in claim 1, the polymer is selected from a group comprising polyacrylonitrile, polysulfone, and polyethersulfone.

13. The porous membrane as claimed in claim 1, wherein the membrane can be prepared in both flat sheet form and hollow fiber form.

14. The porous membrane as claimed in claim 13, wherein the flat sheet membrane is prepared on a moving suitably porous backing.

15. The porous membrane as claimed in claim 13, wherein the hollow fiber form is prepared by passing dope solution through a spinneret followed by gelation and precipitation in non-solvent.

16. The porous membrane as claimed in claim 1, wherein the membrane formed is ultra/micro-filtration in nature.

17. An process for the preparation of a porous membrane of polymers by combining two or more additives, wherein said membrane, useful for ultrafiltration, shows excellent combination of high water flux and solute rejection, said method comprising steps of:
a. adding two or more additives in organic solvent(s) to obtain a dope solution,
b. stirring the dope solution,
c. adding polymer slowly into the dope solution,
d. stirring the dope solution,
e. degassing the dope solution,
f. removing the undissolved particles to obtain homogeneous dope solution,
g. casting the homogeneous dope solution,
h. precipitating the cast in a non-solvent,
i. washing the precipitated cast in running water, and
j. obtaining the porous membrane having excellent combination of high water flux and solute rejection.

18. A process as claimed in claim 17, wherein organic solvent is selected from a group comprising N, N-dimethyl formamide (DMF), N, N-dimethyl acetamide (DMAc), N-methyl pyrolidone (NMP), and dimethyl sulfoxide (DMSO).

19. A process as claimed in claim 17, wherein the concentration of organic acid in dope solution is ranging between 0.1 to 35% (w/w).

20. A process as claimed in claim 17, wherein organic solvent is a mixture of two or more solvents in the ratio ranging between 1:99 to 99:1.

21. A process as claimed in claim 17, wherein additives are selected from a group comprising organic acids, inorganic salts, and viscosity enhancing agent.

22. A process as claimed in claim 21, wherein the additive organic acid is selected from a group comprising tartaric acid, fumaric acid, maleic acid, malonic acid, malic acid, citric acid, lactic acid, polylactic acid, polyacrylic acid, polystyrene sulfonic acid, their partial or total alkali or alkaline earth metal salts, or any other acid containing two or more carboxyl or sulfonic acid groups.

23. A process as claimed in claim 21, wherein inorganic salts are selected from a group comprising halides, and nitrates of Gr. I (A/B), II (A/B) elements of periodic table, and metals Fe, Al, Co, Ru, Zn, Cd, and Hg.

24. A process as claimed in claim 21, wherein concentration of inorganic salt in the dope solution is ranging between 0.1-15% (w/w).

25. A process as claimed in claim 21, wherein viscosity enhancing agent is selected from a group comprising glycerol, water, poly vinyl pyrolidone, polyethylene glycol, and polyethylene oxide.

26. A process as claimed in claim 21, concentration of viscosity enhancing agents in dope solution is ranging between 0.1-30% (w/w).

27. A process as claimed in claim 17, the polymer is selected from a group comprising polyacrylonitrile, polysulfone, and polyethersulfone.

28. A process as claimed in claim 17, wherein the polymer is polyacrylonitrile.

29. A process as claimed in claim 17, wherein the concentration of polymer is ranging between 5-30% (w/w).

30. A process as claimed in claim 17, wherein the degassing of dope solution is for the time duration ranging between 5-25 minutes.

31. A process as claimed in claim 17, wherein the undissolved particles are removed by centrifugation or filtration.

32. A process as claimed in claim 17, wherein non-solvent is selected from a group comprising water, acetone, and alcohol.

33. A process as claimed in claim 17, wherein the non-solvent is water.

34. A process as claimed in claim 32, wherein alcohol is selected from a group comprising methanol, ethanol, and iso propanol, or a mixture thereof.

35. A process as claimed in claim 17, wherein non-solvent is miscible with both organic solvent and the additives.

36. A process as claimed in claim 17, wherein the process is carried out at temperature ranging between 4-50° C.

37. A process as claimed in claim 17, wherein the process is carried out at temperature ranging between 10-30° C.

38. A process as claimed I claim 17, wherein the membrane can be prepared in both flat sheet form and hollow fiber form.

39. A process as claimed in claim 17, wherein the membrane formed is ultra/micro-filtration in nature.
